(19) United States
(12) Patent Application Publication
(10) Pub. No.: US 2026/0289947 A1
(43) Pub. Date: Sep. 24, 2026

(54) METHOD FOR TRAINING A MACHINE LEARNING MODEL FOR INSTANCE SEGMENTATION, TRAINED MACHINE LEARNING MODEL, DEVICE FOR INSTANCE SEGMENTATION, SYSTEM AND COMPUTER PROGRAM

(71) Applicant: Carl Zeiss Microscopy GmbH, Jena (DE)

(72) Inventors: Simon FRANCHINI, München (DE); Noah LATZEL, München (DE); Sandra LEMKE, München (DE); Sebastian SOYER, München (DE)

(21) Appl. No.: 19/571,016

(22) Filed: Mar. 18, 2026

(30) Foreign Application Priority Data
Mar. 24, 2025 (DE) 10 2025 111 290.8

(51) Int. Cl. G06V 10/26; G06V 10/764

(52) U.S. Cl. CPC G06V 10/26; G06V 10/764

(57) ABSTRACT

A method for training a machine learning model for instance segmentation is disclosed, which involves a training image being used, in which no objects to be segmented are annotated and it is known at least for a region that the latter also contains no objects to be segmented. The training of the machine learning model may be made on the basis of the training image.

### TECHNICAL FIELD

This application claims the benefit of German Application No. 10 2025 111 290.8, filed Mar. 24, 2025, the content of which is incorporated herein by reference in its entirety.

### TECHNICAL FIELD

The present application relates to methods for training a machine learning model for instance segmentation of objects in images, correspondingly trained machine learning models, devices for instance segmentation with machine learning models trained in this way, systems comprising such devices, and corresponding computer programs.

### BACKGROUND

Instance segmentation is a computer vision task in which individual instances of objects within an image are identified and separated. A region or a boundary of each instance of objects is detected and each object of the same object class is individually identified. Unlike semantic segmentation, instance segmentation thus distinguishes between individual instances of objects of the same class.

Instance segmentation is usually performed with the aid of trained machine learning models. One application for such instance segmentation is microscopy, in which objects are intended to be identified in images recorded by way of a microscope. One example is microscope recordings of tissue samples in which specific types of cells, for example tumour cells, are to be detected.

One example of such machine learning logic is Mask R-CNN, described in K. He et al., “Mask R-CNN”, IEEE Transactions on Pattern Analysis and Machine Intelligence, vol. 42, no. 2, pp. 386-397, 1 Feb. 2020, where Mask R-CNN stands for Mask Region-based Convolutional Neural Network.

Convolutional neural networks are used here for instance segmentation.

A further approach is based on transformer-based architectures for query-based instance segmentation. Examples here are detections transformers (DETR), see e.g. N. Carion et al., “End-to-End object detection with Transformers”, Computer Vision-ECCV 2020, Mask Transformer, see e.g. B. Cheng et al., “Per pixel classification is not all you need for semantic segmentation”, NeurIPS 2021, or as a further development of this Mask2Former, B. Cheng et al, “Masked-attention Mask Transformer for Universal Image Segmentation”, CVPR 2022.

These procedures use a transformer-based encoder-decoder architecture and learnable object queries (referred to hereinafter as queries for short) in order to segment the objects in an image.

Traditionally, machine learning models for instance segmentation are trained by means of images in which at least one object of a specific object class is annotated. Partially annotated images can also be used, in which only an image region is annotated, but not the entire image. In this regard, DE102022209113A1, for example, describes a training of machine learning models for instance segmentation with partially annotated images, where objects and a background are annotated at least in a part of an image.

If machine learning models trained in this way are then used for inference, that is to say for segmenting images, it may happen that objects are segmented which ought not to be segmented at all, that is to say that they are incorrectly recognized as objects to be segmented. It may also be the case that objects are segmented correctly in principle, but the object mask, that is to say the recognized region of the object, has fragments. This will be illustrated with reference to FIGS. 1A and 1B.

In an image 10 in FIG. 1A, an object 11 is recognized, but the area of the object 11 is not registered completely correctly, and fragments 12A and 12B outside the actual object boundaries are also recognized as being associated with the object. In an image 13 in FIG. 1B, an object 14 was mistakenly recognized, even though in this example the entire image 1B contains no object to be segmented.

Such errors, that is to say the incorrect identification of fragments and the mistaken recognition of entire objects, are false positive errors, that is to say that something is recognized that is not present. Such errors can falsify subsequent image evaluation, for example when counting objects or when determining areas of objects such as cells.

### SUMMARY

There is therefore a need to reduce such false positive errors.

In accordance with one embodiment, a computer-implemented method for training a machine learning model for instance segmentation of objects in images is provided, comprising:
providing a training image, in which there is annotation that the training image or a region of the training image contains no objects to be segmented, and in which no objects to be segmented are annotated, and
training the machine learning model on the basis of the training image.

Here, therefore, a pure negative example is used for training, in which no objects to be segmented are annotated and it is only known that the training image (or the region thereof) contains no objects to be segmented. If objects are then segmented in such a region of a training image, this is therefore in any case a false positive result, and the machine learning model can then be adapted accordingly in the training in order to avoid such false positive results.

A machine learning model should be understood to mean a computer-implemented algorithm that uses techniques and components of machine learning to perform instance segmentation. Examples of such machine learning models have already been explained in the introductory part.

The training image can be based on an actual image recording, for example using a microscope, or can also be a synthetically generated training image.

An annotation should be understood to mean a labelling that can be carried out for example by a user or else automatically, for example in the case of synthetic generation of training images.

Even if a single training image is mentioned above, it should be understood that the above methods can be carried out for a plurality of different training images in which there is annotation that the training image or a region of the training image contains no objects to be segmented.

The method is computer-implemented, i.e., as is customary in the training of machine learning models, it takes place on a computer or a plurality of networked computers, each comprising one or more corresponding processors and being programmed accordingly.

The training can comprise:
segmenting the training image into n segmented objects, n>1, wherein the segmenting yields class probability information and mask probability information for each of the n segmented objects, wherein the class probability information indicates to which class of objects the respective segmented object belongs and with what probability, and the mask probability information indicates which region of the training image belongs to the respective segmented object and with what probability. A value of a cost function can then be determined on the basis of the class probability information and mask probability information, and the machine learning model can be trained on the basis of the value.

Probability information indicates a probability quantitatively. The mask probability information can be specified in the form of a so-called mask logit, and the class probability information as a class logit. In the probability calculation, a logit refers to the natural logarithm of a chance, that is to say the probability divided by the counter-probability (if p is the probability that the object identified by the query belongs to a certain class, the class logit would be ln(p/1 (−p)), where ln is the natural logarithm. If the probability is greater than 50% (p>0.5), the logit is greater than zero, if the probability is exactly 50%, the logit is equal to zero, and if the probability is less than 50% (p<0.5), the logit is less than zero. In this regard, when using logits, for example, zero can be used as a threshold, and an association with a class can be established for a class logit greater than zero, or an association with a respective object mask can be established for a mask logit for an image element, e.g. pixel, greater than zero. However, other threshold values or other representations of probability can also be used as probability information, with appropriately adapted threshold values.

For this purpose, the cost function can have a component which gives negative assessment if a segmented object in the training image (if for the entire training image there is annotation that it contains no objects to be segmented) or in the region of the training image for which there is annotation that it contains no objects to be segmented has mask probability information greater than a first threshold value. For example, the first threshold value can also be zero (e.g. in the case of using mask logits). This component may also be referred to as background loss and thus gives negative assessment if the mask probability information for a respective segmented object indicates that a part of the test image in which there are no objects to be segmented according to the annotation belongs to a segmented object. The threshold value used can be in particular a threshold value which is also used later in the inference as a limit pertaining to the probability as of which an image region, for example pixel, is assessed as being associated with an object.

The training on the basis of the value of the cost function can take place in an inherently conventional way, for example using gradient methods that involve minimizing the cost function. For this purpose, the method is essentially carried out repeatedly, wherein the machine learning model is adapted between the repetitions, for example by changes of weighting factors, in order to minimize the cost function.

The cost function can further have a component which gives negative assessment if a segmented object in the training image (if for the entire training image there is annotation that it contains no objects to be segmented) or in the region of the training image for which there is annotation that it contains no objects to be segmented has a class association probability greater than a second threshold value. By this means, negative assessment is then given in the cost function if an association with an object is established with a probability above the second threshold value, even though there are indeed no objects to be segmented in the training image or in the region of the training image. The second threshold value, too, can be zero in the case of class logits and/or can be a threshold value as of which an association with an object class is established in the inference.

The machine learning model can be in particular a transformer-based machine learning model for query-based instance segmentation, for example such as the DETR or Mask2Former models described above.

Segmenting the training image into n segmented objects can then comprise segmenting the training image with m queries, m>=n. If each query segments an object, it may be the case that m=n. Especially in the present case in which the training image or the region of the training image contains no objects to be segmented, the queries ideally (with correct segmentation) yield no objects, i.e. class probability information and mask probability information below respective threshold values. This can also be implemented in such a way that an object class “no object” is introduced, to which the respective query is then assigned.

In this case, the training can thus comprise:
segmenting the training image with m queries, where m≥1, wherein the segmenting yields class probability information and mask probability information for each of the m queries, wherein the class probability information indicates to which class of objects the segment assigned to the respective query during segmenting belongs and with what probability (or indeed in the case of the object class “no object”, if implemented in this way), and the mask probability information indicates which region of the training image belongs to a specific object, in particular the object recognized by the respective query, and with what probability. A value of a cost function can then be determined on the basis of the class probability information and mask probability information, and the machine learning model can be trained on the basis of the value.

In the case of this query-based instance segmentation, the background loss mentioned above can be calculated as:

$${loss}_{background} ( q ) = {\sum }_{p = 1}^{{P}_{n}} loss ( pixel , q )$$

loss_{background}(q) is the value of this component of the cost function for a respective query q (q=1 . . . m), and the sum

$${\sum }_{p = 1}^{{P}_{n}}$$

is over an pixels p, where Pn denotes the number of pixels of the test image that are to be evaluated.

If there is annotation that the respective pixel contains no object to be segmented (i.e. in the region or the entire test image), it holds true that

$$loss ( pixel , q ) = {\sum }_{c}^{{C}_{n}} - ln ( 1 - p ( pixel , c , q ) ) ,$$

where p(pixel, c, q) is the mask probability information as the probability for the object class c and the sum is over all object classes, and log is the natural logarithm. Otherwise, it holds true that loss(pixel, q)=0. In this case, the abovementioned threshold value is 0: if p(pixel, c, q)=0, the logarithm is equal to 0, so that here there is no contribution to the component of the cost function; as the value of p(pixel, c, q) increases, there is then an increasing contribution, according to the logarithm function.

The above training can be in particular a supplementation for a conventional training which involves providing a further training image (or typically a plurality, in particular a multiplicity, of further training images), in which objects to be segmented are annotated. The training on the basis of this further training image can be carried out in a conventional manner. In particular, when using a transformer-based machine learning model for query-based instance segmentation, a so-called matching, for example Hungarian matching, can then be performed here, in which the queries are assigned to the annotated objects after segmentation. This matching is omitted for the training images that contain no objects to be annotated.

The cost function here can in turn be based on the mask probability information and class probability information, with conventional loss values such as label loss, mask loss and/or in this case also dice loss, wherein the dice loss is used especially if the annotated objects occupy a relatively small proportion of the total area of the second training image. The abovementioned component which gives negative assessment if a query in the image data or in the region of the image data for which there is annotation that it contains no objects to be segmented has mask probability information greater than a first threshold value can additionally be used here as well.

Furthermore, a machine learning model for instance segmentation of objects is provided, said machine learning model being trained using the above method.

Furthermore, a device is provided which has an input for receiving images and also a processor configured to carry out an instance segmentation of objects in the images by means of the trained machine learning model. A system comprising such a device and an image recording device for recording the images is also provided, wherein the image recording device can comprise a microscope.

A computer program comprising a program code is also provided, which is designed to provide the above method for training a machine learning model when implemented on a processor. The computer program can be provided on a storage medium, in particular a physical storage medium such as a memory, a CD-ROM, one or more hard disks or the like. The trained machine learning model can also be provided on such a storage medium.

### BRIEF DESCRIPTION OF THE DRAWINGS

FIGS. 1A and 1B illustrate images for elucidating false positive segmentation.

FIG. 2 is a flowchart of one embodiment.

FIG. 3 shows a block diagram of a system in accordance with one embodiment.

FIG. 4 shows a machine learning model, which is trainable using the disclosed methods, in order to form a trained machine learning model in accordance with one embodiment.

FIGS. 5A and 5B are examples of training images.

FIG. 6 is a flowchart of a method in accordance with one embodiment.

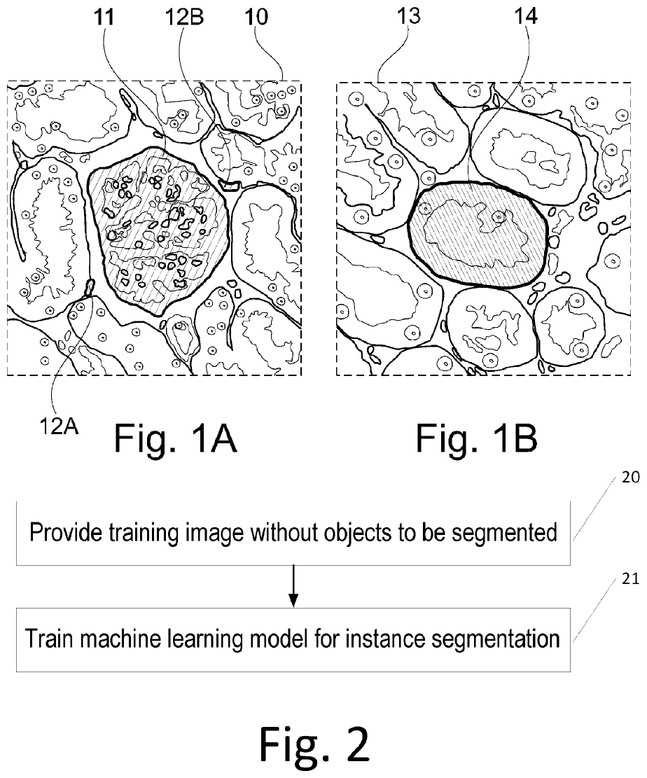

### DETAILED DESCRIPTION

Embodiments are explained in detail below. These embodiments should not be construed as restrictive but rather merely serve for elucidation purposes.

Features of different embodiments can be combined with one another, unless indicated otherwise. Variations, details and the like that are described for one embodiment are also applicable to other embodiments and are therefore not described repeatedly.

FIG. 2 shows a flowchart of a method in accordance with one embodiment. Step 20 involves providing a training image without annotated objects to be segmented.

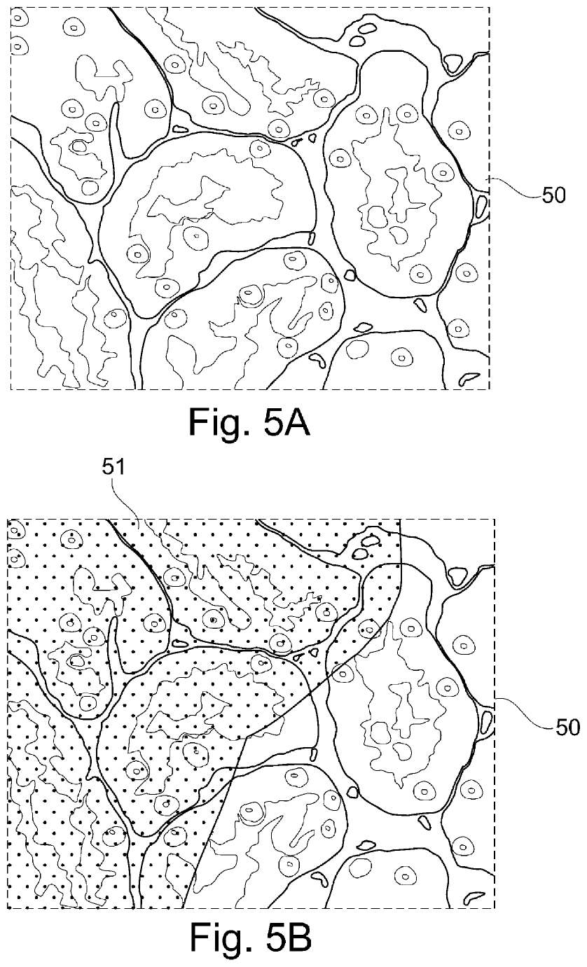

Examples of such training images are illustrated in FIGS. 5A and 5B. FIG. 5A shows a training image 50 in which no object to be segmented is annotated. In addition, in one embodiment for this entire training image 50 there is “annotation” that it contains no objects to be segmented, that is to say that it is known for training that the entire training image 50 contains no objects to be segmented.

An alternative is illustrated in FIG. 5B. It is likewise the case here that no objects to be segmented are annotated in the training image 50. In addition, a region 51 is annotated, in which there are no objects to be segmented. Here, therefore, there is a stipulation only for a part of the training image that here there are no objects to be segmented; in both cases (5A and 5B), however, no objects to be segmented are annotated in the training image. In FIG. 5B, therefore, the fact that objects to be segmented might be situated in the rest of the training image 50 outside the region 51 is not excluded, these objects likewise not being annotated here.

Step 21 in FIG. 2 then involves training a machine learning model for instance segmentation on the basis of the training image.

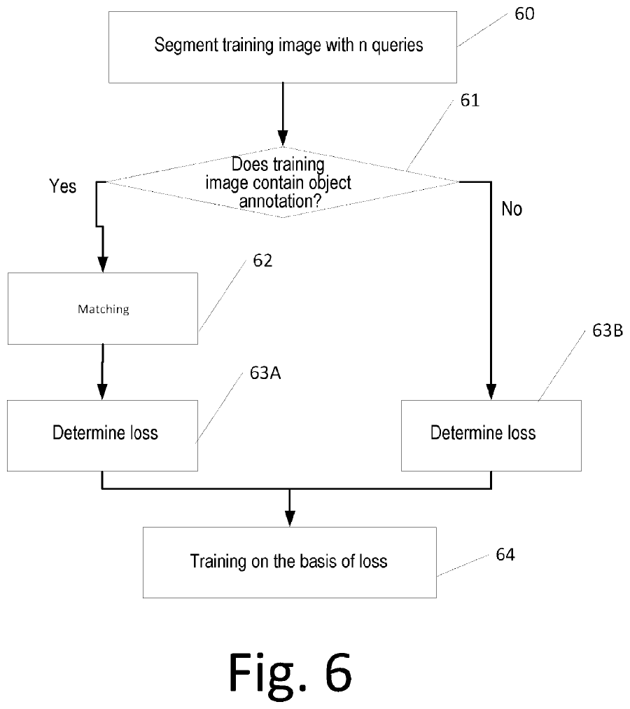

The training can take place for the most part in a conventional manner, in which case, in contrast to training with training images in which objects to be segmented are annotated, no assignment of objects possibly identified in the training image to annotated objects can be effected here. Instead, for the purpose of training, negative assessment should be given if objects are identified here in the training image or in the annotated region (51 in FIG. 5B). One implementation option for such training will also be explained later with reference to FIG. 6.

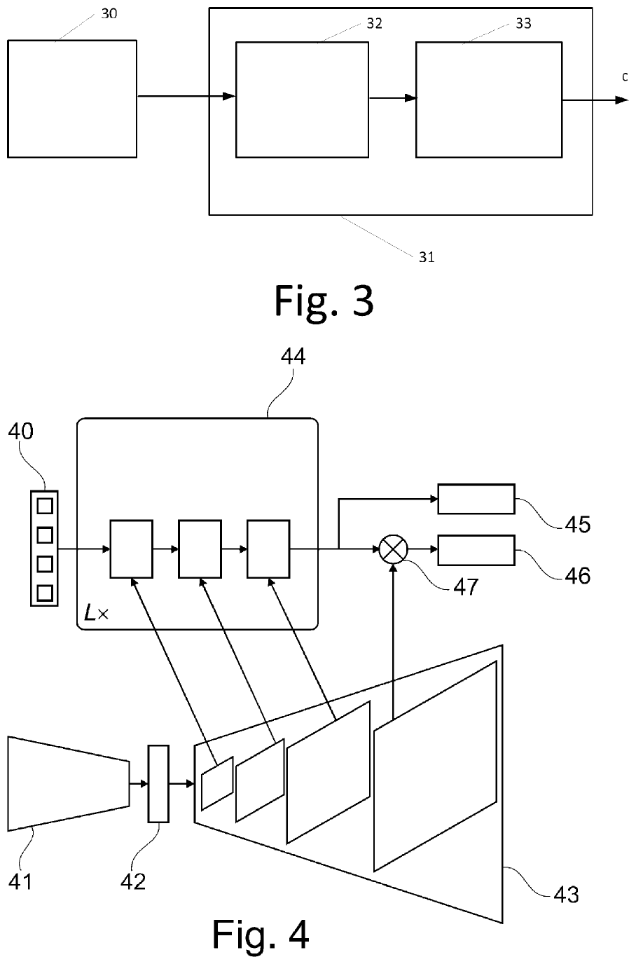

Before that, systems and possible machine learning models will now be briefly discussed with reference to FIGS. 3 and 4. As already explained further above, however, the method is generally applicable to machine learning models for instance segmentation.

FIG. 3 shows a system in accordance with one exemplary embodiment. The system in FIG. 3 shows an image recording device for supplying images in which objects are to be segmented. For this purpose, the image recording device can contain one or more cameras. The image recording device can also contain a microscope, wherein the images are then recorded through the microscope using a camera, for example. For other types of microscopes, e.g. laser scanner microscopes, scanning of a sample can also be effected in order to obtain images. For example, images of tissue samples can be recorded using such microscopes. Furthermore, the system has a computing device 31, on which a machine learning model 32, 33 runs. The machine learning model 32, 33 has two stages 32 and 33 in the example illustrated. The machine learning model is trained using the methods described herein and can then be used as a trained machine learning model for inference. For example, a first stage 32 can be used for preprocessing, and a second stage 33 can contain a transformer, which then generates a classification c. As explained in the introduction, the machine learning model can be designed for query-based instance segmentation and can be a DETR-based model or a Mask2Former model. However, non-transformer-based machine learning models such as the Mask R-CNN architecture mentioned above are also possible.

As an example of a machine learning model, FIG. 4 illustrates the Mask2Former model according to Cheng et al, “Masked-attention Mask Transformer for Universal Image Segmentation”, as already cited above. Apart from the training described here, which leads to a correspondingly trained model, the model in FIG. 4 can be executed in a conventional manner and will therefore only be described briefly. Images (training images during training and images to be analysed during inference) are fed to a backbone 41, which can be implemented for example as a neural network and is designed to extract features with low resolution 42. The images can also be 3D images, and the backbone 41 can extract 2D features from them. These features are then upscaled in a pixel decoder. A transformer decoder 44 obtains the image data conditioned by the pixel decoder 43 and also a multiplicity of queries 40, to which it then assigns class probability information 45, for example in the form of class logits, and mask probability information 46 (via a combination 47 with the image data supplied by the pixel decoder 43), for example in the form of mask logits. The class probability information 45 indicates to which object class a query is assigned, and the mask probability information 46 indicates the corresponding image region.

FIG. 6 shows a more detailed flowchart for training a machine learning model, in this case for query-based instance segmentation, in accordance with one embodiment. Firstly, a training image is provided. The training image can be either a conventional training image, in which objects to be segmented are annotated, or a training image as explained under FIGS. 5A and 5B, which has no object annotations and in which at least for a region there is annotation that it contains no objects to be segmented. For training, the method in FIG. 6 is then carried out with a multiplicity of training images, wherein some of the training images are of the second mentioned type, that is to say training images which contain no object annotations.

In step 60, the training image is segmented with n queries by means of the machine learning model to be trained, where n≥1. For each query, class probability information and mask probability information are output.

In a later inference with the trained machine learning model, all queries for which all items of class probability information are less than a first threshold value are then discarded, since in the case of this model it is then assumed that they do not correspond to an identified object owing to the low probability. Alternatively, queries that do not detect an object are assigned to a “no object” class with corresponding class probability information, as explained above. The remaining queries are each assigned to the object class for which the class probability information indicates the highest probability of association. In order to obtain a mask for the object, that is to say the region in which the object lies, a second threshold value is used. All image regions, e.g. pixels, with mask probability information above this second threshold value are then part of the object mask.

For training, step 61 then involves distinguishing whether the training image contains object annotations, that is to say whether it is a conventional training image with object annotations or a training image as used in embodiments without object annotations, as explained with reference to FIGS. 5A and 5B. If the training image contains object annotations (Yes for 61), a conventional training is carried out. For this purpose, in step 62, firstly a matching algorithm such as a “Hungarian matching” is carried out in order to assign each object annotated in the training image to a respective query in a 1:1 matching. Each annotated object is assigned to that query which simultaneously has the most precise object mask and the highest probability of association with the object class of the annotated object.

A matching algorithm is generally an algorithm whose main task is to optimally assign the objects predicted by the model (according to the class probability information and the mask probability information) to the actual, that is to say annotated, objects in the training image. Since the machine learning model makes a fixed number of object predictions (n queries), it is necessary to decide which prediction corresponds to which annotated object. Matching algorithms such as the Hungarian matcher solve this assignment problem by minimizing a cost function that takes into account various variables, in particular the accuracy of the assignment to the region of the object on the basis of the mask probability information and the class assignment to the object on the basis of the class probability information.

Step 63A then involves determining a value of a cost function (loss function), also referred to as loss for short. This loss here can be composed of label loss (which essentially assesses the accuracy of the class assignment), mask loss (which essentially assesses the accuracy of the mask), dice loss (which, as in conventional methods, is used to take account of the fact that an area of the annotated objects is often much smaller than a total area of the image) or uses other conventional components of cost functions used in the respective training for the respective machine learning model. Step 64 then involves carrying out a training on the basis of the loss, for example by means of gradient methods, in which the machine learning model is adapted step by step in order to minimize the loss.

If, on the other hand, in 61 the training image contains no object annotations, i.e. is a training image as described with reference to FIGS. 5A and 5B, no matching can take place, since after all there are no annotated objects. Here, a value of a cost function is determined directly in step 63B. Here, dice loss and mask loss as in 63A cannot be determined, since the queries cannot be assigned to any objects and thus it is not possible to determine how well the mask matches the annotated object contour according to the mask probability information. As compensation, a background loss can be introduced as a component as explained above, said background loss negatively assessing queries with positive mask probability information, for example mask probability information above a threshold value, in regions that are known to contain no objects (for example the entire image 50 in FIG. 5A or the marked region 51 in FIG. 5B). If logit values are used as class or mask probability information, the threshold value can also be set to zero, which corresponds to a probability greater than 50%. Such a background loss can additionally be taken into account in step 63A as well, since no queries should segment objects in background regions that are annotated as such. Moreover, in 63B the label loss can continue to be used as a component of the cost function, in which case there is then punishment if in the case of a query that can be assigned to the region 51 (or to the entire training image 50 in FIG. 5A), for which there is annotation that there are no objects to be segmented, an association with an object class is recognized (since there are no object annotations). With this loss, too, a corresponding training on the basis of the loss is then carried out in 64.

As already mentioned, the method in FIG. 6 can be carried out with a multiplicity of training images, some of the training images containing no object annotations. In this way, a respective trained model can be generated from the machine learning models in FIGS. 3 and 4, and can then be used for inference.

What is claimed is:

1. A computer-implemented method for training a machine learning model for instance segmentation of objects in images, comprising:
providing a training image, in which there is annotation that the training image or a region of the training image contains no objects to be segmented, and in which no objects to be segmented are annotated, and
training the machine learning model on the basis of the training image.

2. The method according to claim 1, wherein the training comprises:
segmenting the training image into n segmented objects, n>1, wherein the segmenting yields class probability information and mask probability information for each of the n segmented objects, wherein the class probability information indicates to which class of objects the respective segmented object belongs and with what probability, and the mask probability information indicates which region of the training image belongs to the respective segmented object and with what probability,
determining a value of a cost function on the basis of the class probability information and the mask probability information, and
training the machine learning model on the basis of the value.

3. The method according to claim 2, wherein the cost function has a component which gives negative assessment if a segmented object in the training image or the region of the training image for which there is annotation that it contains no objects to be segmented has mask probability information greater than a first threshold value.

4. The method according to claim 2, wherein the cost function has a component which gives negative assessment if a segmented object assigned to the training image or to the region of the training image for which there is annotation that the training image or the region contains no objects to be segmented has class probability information greater than a second threshold value.

5. The method according to claim 1 wherein the machine learning model is a transformer-based machine learning model for query-based instance segmentation and wherein segmenting the training image into n segmented objects comprises segmenting the training image with m queries, m>=n.

6. The method according to claim 1, further comprising:
providing a further training image, in which at least one object to be segmented is annotated, and
training the machine learning model on the basis of the further training image.

7. A non-transitory computer readable medium storing a machine learning model for instance segmentation of objects in images, trained using the method according to claim 1.

8. A device for instance segmentation of objects in images, comprising:
an input for receiving an image, and
a processor configured to segment objects in the received image by means of the machine learning model of claim 7.

9. A system, comprising:
an image recording device for recording an image, and
the device according to claim 8, wherein the input of the device is coupled to the image recording device in order to receive the recorded image.

10. A system according to claim 9, wherein the image recording device comprises a microscope.

11. A non-transitory computer readable medium storing a computer program comprising a program code designed to carry out the method according to claim 1 when executed on a processor.
